(19) United States
(12) Patent Application Publication
(10) Pub. No.: US 2022/0276360 A1
(43) Pub. Date: Sep. 1, 2022

(54) CALIBRATION METHOD AND APPARATUS FOR SENSOR, AND CALIBRATION SYSTEM

(71) Applicant: Shanghai SenseTime Intelligent Technology Co., Ltd., Shanghai (CN)

(72) Inventors: Zheng MA, Shanghai (CN); Guohang YAN, Shanghai (CN); Chunxiao LIU, Shanghai (CN); Jianping SHI, Shanghai (CN)

(21) Appl. No.: 17/747,271

(22) Filed: May 18, 2022

Related U.S. Application Data
(63) Continuation of application No. PCT/CN2020/122559, filed on Oct. 21, 2020.

(30) Foreign Application Priority Data
Nov. 18, 2019 (CN) 201911126534.8

(51) Int. Cl. G01S 7/497; G06T 7/80; G01S 17/42

(52) U.S. Cl. CPC G01S 7/497; G06T 7/80; G01S 17/42

(57) ABSTRACT

Methods, apparatus, systems for calibrating sensors are provided. In one aspect, a sensor includes a radar and a camera, and a first calibration plate is located within a common field of view range of the radar and the camera. A calibration method for the sensor includes: collecting a plurality of first images by the camera, position-orientation information of the first calibration plate in position-orientations in the plurality of first images being different; obtaining a first intrinsic parameter of the camera; determining an extrinsic parameter of the first calibration plate in each position-orientation relative to the camera according to the first intrinsic parameter and the plurality of first images; obtaining multiple sets of radar point cloud data of the first calibration plate in each position-orientation; and determining a target extrinsic parameter between the radar and the camera according to the extrinsic parameter and the multiple sets of radar point cloud data.

### CROSS REFERENCE TO RELATED APPLICATIONS

This application is a continuation application of International Application No. PCT/CN2020/122559 filed on Oct. 21, 2020, which claims priority to a Chinese Patent Application No. 201911126534.8 filed on Nov. 18, 2019 and titled “CALIBRATION METHOD AND APPARATUS FOR SENSOR, STORAGE MEDIUM, AND CALIBRATION SYSTEM”, the entire contents of which are incorporated herein by reference.

### TECHNICAL FIELD

The present disclosure relates to the field of computer vision, and more particular, to a calibration method and apparatus for a sensor, and a calibration system.

### BACKGROUND

With the continuous development of computer vision, more and more sensors are deployed in machine devices, and different sensors can provide different types of data. For example, a machine device includes a combination of a radar and a camera, based on the data provided by the radar and the camera, the machine device can learn to perceive a surrounding environment.

In a process of using the radar and the camera at the same time, an accuracy of an extrinsic parameter between the radar and the camera determines an accuracy of environment perception.

### SUMMARY

The present disclosure provides a calibration method and apparatus for a sensor, and a calibration system, so as to realize a joint calibration of the radar and the camera.

According to a first aspect of the embodiments of the present disclosure, there is provided a calibration method for a sensor, including: collecting a plurality of first images by a camera of the sensor, wherein the sensor includes the camera and a radar, a first calibration plate is located within a common field of view range of the radar and the camera, and position-orientation information of the first calibration plate in respective position-orientations in the plurality of first images is different; obtaining a first intrinsic parameter of the camera calibrated in advance; respectively determining an extrinsic parameter of the first calibration plate in each of the respective position-orientations relative to the camera according to the first intrinsic parameter and the plurality of first images; obtaining multiple sets of radar point cloud data of the first calibration plate in the respective position-orientations; and determining a target extrinsic parameter between the radar and the camera according to the extrinsic parameter of the first calibration plate in each of the respective position-orientations relative to the camera and the multiple sets of radar point cloud data.

According to a second aspect of the embodiments of the present disclosure, there is provided a calibration apparatus for a sensor, including: at least one processor; and at least one non-transitory memory coupled to the at least one processor and storing programming instructions for execution by the at least one processor to: collect a plurality of first images by a camera of the sensor, wherein the sensor includes the camera and a radar, a first calibration plate is located within a common field of view range of the radar and the camera, and position-orientation information of the first calibration plate in respective position-orientations in the plurality of first images is different; obtain a first intrinsic parameter of the camera calibrated in advance; respectively determine an extrinsic parameter of the first calibration plate in each of the respective position-orientations relative to the camera according to the first intrinsic parameter and the plurality of first images; obtain multiple sets of radar point cloud data of the first calibration plate in the respective position-orientations; and determine a target extrinsic parameter between the radar and the camera according to the extrinsic parameter of the first calibration plate in each of the respective position-orientations relative to the camera and the multiple sets of radar point cloud data.

According to a third aspect of the embodiments of the present disclosure, there is provided a calibration system, including: a camera; a radar; a first calibration plate, wherein the first calibration plate is located within a common field of view range of the camera and the radar, and position-orientation information of the first calibration plate in respective position-orientations at different collection times is different; and a calibration device including: at least one processor; and at least one non-transitory memory coupled to the at least one processor and storing programming instructions for execution by the at least one processor to: collect a plurality of first images by a camera; obtain a first intrinsic parameter of the camera calibrated in advance; respectively determine an extrinsic parameter of the first calibration plate in each of the respective position-orientations relative to the camera according to the first intrinsic parameter and the plurality of first images; obtain multiple sets of radar point cloud data of the first calibration plate in the respective position-orientations; and determine a target extrinsic parameter between the radar and the camera according to the extrinsic parameter of the first calibration plate in each of the respective position-orientations relative to the camera and the multiple sets of radar point cloud data.

According to the embodiments, in the process of calibrating the sensor, for example, in the case of calibrating the target extrinsic parameter between the radar and the camera, the first intrinsic parameter of the camera calibrated in advance can be obtained, and the extrinsic parameter of the first calibration plate in each of the respective position-orientations relative to the camera can be respectively determined according to the first intrinsic parameter of the camera calibrated in advance, so that the target extrinsic parameter between the radar and the camera can be determined according to the extrinsic parameter of the first calibration plate in each of the respective position-orientations relative to the camera and the multiple sets of radar point cloud data. In the calibration process, the extrinsic parameter of the first calibration plate relative to the camera is obtained according to the first intrinsic parameter of the camera calibrated in advance and the plurality of first images, that is, in the case that a relative position relationship between the camera and the radar or a pitch angle changes, the calibration for the sensor can be realized based on the first intrinsic parameter of the camera calibrated in advance.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the disclosure.

FIG. 1 is a flowchart showing a calibration method for a sensor according to an exemplary embodiment of the present disclosure.

FIG. 2 is a schematic diagram showing a common field of view according to an exemplary embodiment of the present disclosure.

FIG. 3 is a schematic diagram showing a calibration plate in different orientations according to an exemplary embodiment of the present disclosure.

FIG. 4 is a schematic diagram showing a transmission of a radar according to an exemplary embodiment of the present disclosure.

FIG. 5 is a flowchart showing a calibration method for a sensor according to another exemplary embodiment of the present disclosure.

FIG. 6 is a schematic diagram showing a field of view of a camera according to an exemplary embodiment of the present disclosure.

FIG. 7 is a flowchart showing a calibration method for a sensor according to another exemplary embodiment of the present disclosure.

FIG. 8 is a schematic diagram showing a second image including a second calibration plate according to an exemplary embodiment of the present disclosure.

FIG. 9 is a flowchart showing a calibration method for a sensor according to still another exemplary embodiment of the present disclosure.

FIG. 10A is a schematic diagram showing a scene in which a preset point of is projected according to an exemplary embodiment of the present disclosure.

FIG. 10B is a schematic diagram showing a scene in which a coordinate pair with a corresponding relationship is determined according to an exemplary embodiment of the present disclosure.

FIG. 11 is a flowchart showing a calibration method for a sensor according to still another exemplary embodiment of the present disclosure.

FIG. 12 is a flowchart showing a calibration method for a sensor according, to still another exemplary embodiment of the present disclosure.

FIG. 13 is a flowchart showing a calibration method for a sensor according to still another exemplary embodiment of the present disclosure.

FIG. 14 is a flowchart showing a calibration method for a sensor according to still another exemplary embodiment of the present disclosure.

FIG. 15 is a flowchart showing a calibration method for a sensor according, to still another exemplary embodiment of the present disclosure.

FIG. 16 is a flowchart showing a calibration method for a sensor according to still another exemplary embodiment of the present disclosure.

FIG. 17 is a schematic diagram showing determination of a plurality of first vectors according to an exemplary embodiment of the present disclosure.

FIG. 18 is a flowchart, showing a calibration method for a sensor according to still another exemplary embodiment of the present disclosure.

FIG. 19 is a flowchart showing a calibration method for a sensor according to still another exemplary embodiment of the present disclosure.

FIG. 20 is a flowchart showing a calibration method for a sensor according to still another exemplary embodiment of the present disclosure.

FIG. 21A is a schematic diagram showing projection of a first calibration plate by a radar according to an exemplary embodiment of the present disclosure.

FIG. 21B is another schematic diagram showing projection of the first calibration plate by a radar according to an exemplary embodiment of the present disclosure.

FIG. 22 is a schematic diagram showing deployment of radars and cameras on a vehicle according to an exemplary embodiment of the present disclosure.

FIG. 23 is a schematic diagram showing positions of a first calibration plate and a second calibration plate corresponding to radars and cameras deployed on a vehicle according to an exemplary embodiment of the present disclosure.

FIG. 24 is a block diagram showing a calibration apparatus for a sensor according to an exemplary embodiment of the present disclosure.

FIG. 25 is a block diagram showing a calibration apparatus for a sensor according to another exemplary embodiment of the present disclosure.

### DETAILED DESCRIPTION

Exemplary embodiments will be described in detail herein, with the illustrations thereof represented in the drawings. When the following descriptions involve the drawings, like numerals in different drawings refer to like or similar elements unless otherwise indicated. The implementation manners described in the following exemplary embodiments do not represent all embodiments consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. The singular forms “a/an”, “the” and “said” used in the present disclosure and the appended claims are also intended to include plurality, unless the context clearly indicates other meanings. It should also be understood that the term “and/or” as used herein refers to and includes any and all possible combinations of one or more of the associated listed items.

It should be understood that, although terms “first”, “second,” “third,” and the like may be used to describe various information in the present disclosure, the information should not be limited to these terms. These terms are only used to distinguish the same type of information from each other. For example, without departing from the scope of the present disclosure, first information may also be referred to as second information, and similarly, second information may also be referred to as first information. Depending on the context, the word “if” as used herein may be interpreted as “when” or “upon” or “in response to determining”.

The present disclosure provides a calibration method for a sensor. The calibration for the sensor refers to a calibration for an intrinsic parameter and an extrinsic parameter of the sensor.

The intrinsic parameter of the sensor refers to a parameter used to reflect the characteristics of the sensor itself. After the sensor leaves a factory, the intrinsic parameter is unchanged in theory, however, in actual use, the intrinsic parameter may change. Taking a camera as an example, as the camera is used over time, changes in a position relationship of various parts of the camera will lead to changes in the intrinsic parameter. A calibrated intrinsic parameter is generally only a parameter that approximates a real intrinsic parameter, not a true value of the intrinsic parameter.

The following takes a sensor including a camera and a radar as an example to illustrate the intrinsic parameter of the sensor. The intrinsic parameter of the camera refers to a parameter used to reflect the characteristics of the camera itself, and may include, but is not limited to, at least one of the followings, that is, the intrinsic parameter of the camera may be one or more of a plurality of parameters listed below: u₀, v₀, Sₓ, S_{y}, f, and r. Here, u₀ and v₀ respectively represent numbers of horizontal and vertical pixels that differ between the origin of the pixel coordinate system and the origin of the camera coordinate system where the camera is located, in pixels; Sₓ and S_{y} are numbers of pixels per unit length in the horizontal and vertical directions, respectively, and the unit length may be a millimeter; f is a focal length of the camera; and r is a distance of the pixel from the center of the imager due to image distortion, in the embodiment of the present disclosure, the center of the imager is a focus center of the camera. The camera described in the present disclosure may be a camera, a video camera, or other device with a photographing function, which is not limited in the present disclosure.

The intrinsic parameter of the radar refers to a parameter that can be used to reflect the characteristics of the radar itself, and may include, but is not limited to, at least one of the followings, that is, the intrinsic parameter of the radar may be one or more of a plurality of parameters listed below: power and type of the transmitter, sensitivity and type of the receiver, parameters and type of the antenna, a number and type of the display, etc. The radar described in the present disclosure may be a. Light Detection and Ranging (LiDAR) system, or a radio radar, which is not limited in the present disclosure.

The extrinsic parameter of the sensor refers to the parameter of a conversion relationship between a position of an object in the world coordinate system and a position of the object in the sensor coordinate system. It should be noted that, when a plurality of sensors are included, the extrinsic parameter of the sensor also includes parameters for reflecting the conversion relationship between a plurality of sensor coordinate systems. The following also takes the sensor including a camera and a radar as an example to illustrate the extrinsic parameter of the sensor.

The extrinsic parameter of the camera refers to a parameter used to convert a point from a world coordinate system to a camera coordinate system. In the embodiment of the present disclosure, an extrinsic parameter of a calibration plate relative to a camera can be used to reflect change parameters of the position and/or an orientation required for conversion of the calibration plate in the world coordinate system to the camera coordinate system, etc.

The extrinsic parameter of a camera may include, but is not limited to, one or a combination of a plurality of the following parameters: change parameters of the position and/or the orientation required for conversion of the calibration plate in the world coordinate system to the camera coordinate system, etc.

In addition, for the camera, distortion parameters also need to be considered. The distortion parameters include radial distortion parameters and tangential distortion coefficients. The radial distortion and tangential distortion are position deviations of an image pixel along the length direction or the tangent direction with the distortion center as the center point, respectively, thereby resulting in image deformation.

The change parameters of the position and/or the orientation required for conversion of the calibration plate in the world coordinate system to the camera coordinate system may include a rotation matrix R and a translation matrix T. Here, the rotation matrix R is rotation angle parameters respectively relative to three coordinate axes x, y and z when the calibration plate in the world coordinate system is to be converted to the camera coordinate system, and the translation matrix T is translation parameters of an origin when the calibration plate in the world coordinate system is to be converted to the camera coordinate system.

The extrinsic parameter of the radar refers to the parameter used to convert a point from the world coordinate system to the radar coordinate system. In the embodiment of the present disclosure, an extrinsic parameter of a calibration plate relative to a radar can be used to reflect the change parameters of the position and//or the orientation required for conversion of the calibration plate in the world coordinate system to the radar coordinate system, etc.

A target extrinsic parameter between the camera and the radar refers to a parameter used to reflect a conversion relationship between the radar coordinate system and the camera coordinate system. An extrinsic parameter between the camera and the radar can reflect changes of the radar coordinate system relative to the camera coordinate system in position and orientation, etc.

For example, the sensor can include the camera and the radar, the calibration for the sensor refers to the calibration for one or a combination of a plurality of the intrinsic parameter of the camera, the intrinsic parameter of the radar, and the target extrinsic parameter between the camera and the radar. Here, the above-mentioned intrinsic parameter and/or extrinsic parameter can be determined by means of a calibration plate, for example, the target extrinsic parameter between the camera and the radar can be determined by means of the extrinsic parameter of the calibration plate relative to the camera and the extrinsic parameter of the calibration plate relative to the radar. It should be noted that, the actually calibrated parameters may include, but are not limited to, those listed above.

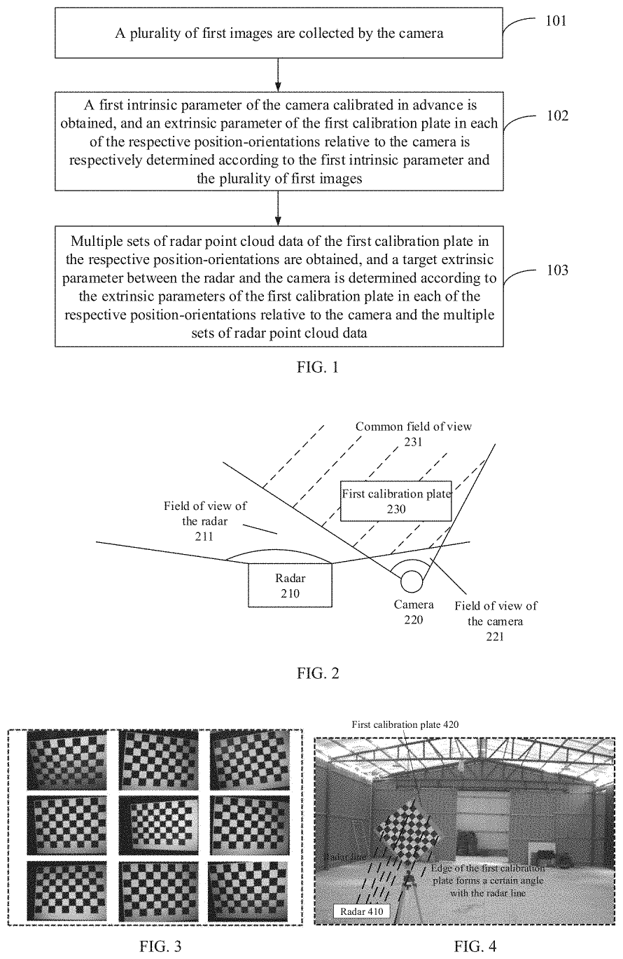

For example, as shown in FIG. 1, when the sensor includes the camera and the radar, the calibration method for the sensor may include the following steps,

In step 101, a plurality of first images are collected by the camera, wherein position-orientation information of a first calibration plate in respective position-orientations in the plurality of first images is different.

In the embodiment of the present disclosure, the radar may be a lidar that detects characteristic quantities such as a position and speed of a target by emitting a laser beam, or a millimeter-wave radar that operates in a millimeter-wave frequency band, or the like.

A field of view is a range that can be covered by the emitted light, electromagnetic waves, etc., when the position of the sensor remains unchanged. In the embodiment of the present disclosure, taking the sensor including a radar as an example, the field of view refers to a range that can be covered by laser beams or electromagnetic waves emitted by the radar, and taking the sensor including a camera as an example, the field of view refers to a range that can be captured by the lens of the camera.

In the embodiment of the present disclosure, the first calibration plate 230 is located in a range of a common field of view 231 of the radar 210 and the camera 220, as shown in FIG. 2, for example. Here, the range of the common field of view 231 refers to a part where ranges covered by respective sensing elements included in the sensor overlap with each other, that is, the part (the part indicated by the dashed line in the figure) where the range covered by the radar 210 (the field of view 211 of the radar in the figure) and the range captured by the camera 220 (the field of view 221 of the camera in the figure) overlap.

In the embodiment of the present disclosure, the first calibration plate can be a circular, rectangular or square array plate with a fixed pitch pattern. For example, as shown in any of the first images in FIG. 3, a rectangular array plate with black and white grids alternated can be used. In addition, the pattern of the calibration plate can also include other regular patterns, or patterns that are irregular but have characteristic parameters such as characteristic point sets, characteristic edges, and the like. The shape, pattern and the like of the calibration plate are not limited here.

In this step, in order to improve the accuracy of the target extrinsic parameter between the radar and the camera, the number of the first images collected by the camera may be multiple, for example, more than 20. in the embodiment of the present disclosure, the position-orientations of the first calibration plate in the collected plurality of first images may be different, that is, there are at least some images in the plurality of first images that respectively show the different position-orientations of the first calibration plate, such as different positions and/or orientations. For example, in the plurality of first images shown in FIG. 3, the first calibration plate has orientation changes in three dimensions of a pitch angle, a roll angle, and a yaw angle. This means that the plurality of first images can be collected when the first calibration plate is in different positions and/or orientations, that is, the position-orientation information of the first calibration plate included in different first images may be same or different, and there are at least two first images including different position-orientation information of the first calibration plate. Here, each first image needs to include a complete first calibration plate.

Here, the number of first images may be m, and the number of position-orientations of the first calibration plate may be n, and both m and n are integers greater than or equal to 2.

Here, the position-orientation information includes information used to reflect the orientation of the first calibration plate in the three-dimensional space. For example, the position-orientation information of the first calibration plate shown in FIG. 3 may be orientation change of the first calibration plate in at least one of the three dimensions of the pitch angle, the roll angle, and the yaw angle. In addition, in the process of capturing the first images by the camera, the first calibration plate may be in a static state. For example, a bracket can be used to fix the first calibration plate.

In one implementation, the position-orientation information also includes position information. The collected plurality of first images may include images of the first calibration plate at various distances (i.e., small distance, moderate distance, large distance, etc.) in different position-orientations. In order to ensure that the laser generated by the radar can cover the complete first calibration plate, the first calibration plate is usually kept far away from the radar in the process of deploying the first calibration plate. In the process of collecting images of the first calibration plate deployed at different distances, for the case where the distance di from the first calibration plate to the camera is relatively small, for example, the distance d₁ is less than a distance threshold D₁, a plurality of first images including the first calibration plate in different orientations are collected. For the case where d₁ is relatively large, for example, d₁ is greater than a distance threshold D₂, a plurality of first images including the first calibration plate in different orientations can be additionally collected. For the case where the distance d₁ is moderate, for example, the distance d₁ is between the above two distance thresholds, that is, D₁<d₁<D₂, a plurality of first images including the first calibration plate in different orientations can be additionally collected. In this way, the first images captured at various distances between the first calibration plate and the camera can be obtained. The first images at different distances have different position-orientation information.

In the embodiment of the present disclosure, in order to more accurately determine the extrinsic parameter of the first calibration plate relative to the camera subsequently, the plurality of first images may include a complete first calibration plate. For example, in the plurality of first images shown in FIG. 3, a ratio of the area of the first calibration plate to the area of the first image are different. For example, when the distance d₁ is relatively large, the area of the first calibration plate in the first image occupies a relatively small proportion, and when the distance d₁ is relatively small, the area of the first calibration plate in the first image occupies a relatively large proportion.

In step 102, a first intrinsic parameter of the camera calibrated in advance is obtained, and an extrinsic parameter of the first calibration plate in each of the respective position-orientations relative to the camera is respectively determined according to the first intrinsic parameter and the plurality of first images.

Due to the large distortion at the edge of the, field of view of the camera, it is necessary to determine the distortion parameters more accurately. In addition, the distortion parameters have a great influence on the intrinsic parameter of the camera. Therefore, if the intrinsic parameter of the camera is directly calibrated according to the plurality of first images, the calibration result may not be accurate enough. In the embodiment of the present disclosure, the first intrinsic parameter of the camera calibrated in advance can be directly obtained. According to the first intrinsic parameter of the camera and the plurality of first images collected by the camera, the extrinsic parameters of the first calibration plate in different position-orientations relative to the camera can be determined.

In the embodiment of the present disclosure, the first intrinsic parameter of the camera is an intrinsic parameter of the camera obtained by calibrating the camera when the sensor is initially calibrated. In the case of initial calibration of the intrinsic parameter of the camera, a plurality of second images including a complete second calibration plate are collected by the camera, and the first intrinsic parameter of the camera is calibrated according to the plurality of second images. Here, the position-orientation information of the second calibration plate in the plurality of second images is different. The second calibration plate may be close to the camera and close to the edge of the field of view of the camera, so that the first intrinsic parameter of the camera determined in this way can be more accurate than the intrinsic parameter of the camera calibrated using the plurality of first images. In the embodiment of the present disclosure, after the first intrinsic parameter of the camera is initially calibrated, in the case of the re-calibration of the sensor, the first intrinsic parameter of the camera calibrated in advance can be directly obtained. Further, methods such as Zhang Zhengyou calibration method can be used to calibrate the first intrinsic parameter of the camera. The extrinsic parameters of the first calibration plate relative to the camera are determined according to the first intrinsic parameter and the plurality of first images, including a rotation matrix R and a translation matrix T.

In step 103, multiple sets of radar point cloud data of the first calibration plate in the respective position-orientations are obtained, and a target extrinsic parameter between the radar and the camera is determined according to the extrinsic parameters of the first calibration plate in each of the respective position-orientations relative to the camera and the multiple sets of radar point cloud data.

In the embodiment of the present disclosure, the plurality of first images of the first calibration plate in different position-orientations have been collected by the camera, and for the first calibration plate in each position-orientation, corresponding radar point cloud data can be simultaneously collected. Here, the radar point cloud data is data including a plurality of radar points generated by the laser or electromagnetic waves emitted by the radar passing through the first calibration plate in different position-orientations. In order to improve the accuracy of the finally determined target extrinsic parameter between the radar and the camera, the radar point cloud data includes the point cloud data obtained based on the complete first calibration plate.

For example, as shown in FIG. 4, the edges of the first calibration plate 420 are not parallel to the laser or electromagnetic waves emitted by the radar 410, and there may be a certain angle, so as to ensure that each edge of the first calibration plate 420 can be passed through by the laser or electromagnetic waves emitted by the radar 410, so that target radar point cloud data matching the first calibration plate in the radar point cloud data can be better determined subsequently.

The target extrinsic parameter between the radar and the camera belongs to the extrinsic parameter between the camera and the radar.

In the embodiment, during the calibration process, the extrinsic parameter of the first calibration plate relative to the camera is obtained according to the first intrinsic parameter of the camera calibrated in advance and the plurality of first images, that is, when the relative position relationship between the camera and the radar or the pitch angle changes, the calibration for the sensor can be realized based on the first intrinsic parameter of the camera calibrated in advance.

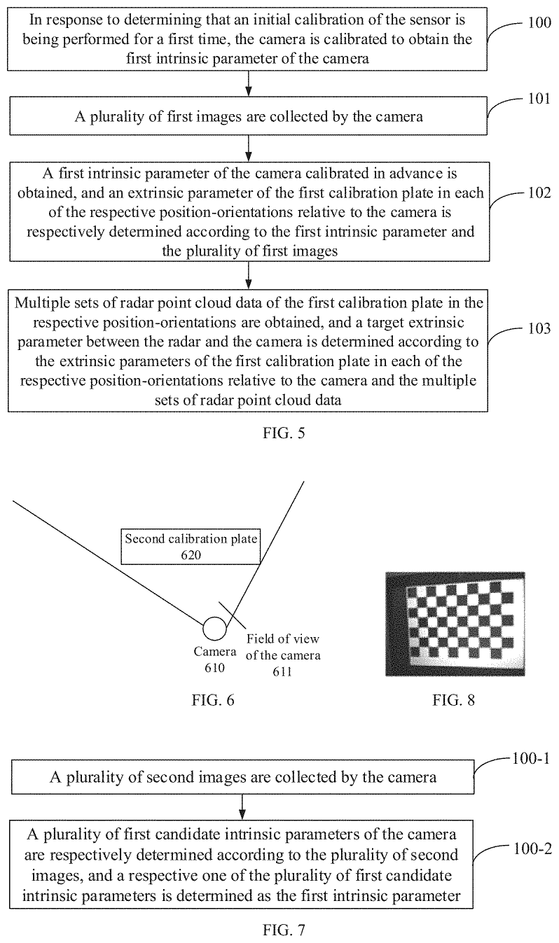

In some optional embodiments, for example, as shown in FIG. 5, before obtaining the first intrinsic parameter of the camera calibrated in advance in the above step 102, the method further includes step 100.

In step 100, in response to determining that an initial calibration of the sensor is being performed for a first time, the camera is calibrated to obtain the first intrinsic parameter of the camera.

In the embodiment of the present disclosure, if the sensor is calibrated for a first time, the camera can be calibrated to obtain the first intrinsic parameter of the camera.

Obtaining the first intrinsic parameter of the camera calibrated in advance in step 102 may include: in response to calibrating the sensor again, obtaining the first intrinsic parameter of the camera obtained by the initial calibration of the sensor is obtained.

In the case that the sensor is calibrated again, for example, if the target extrinsic parameter between the radar and the camera in the sensor needs to be calibrated again, the first intrinsic parameter of the camera obtained by the initial calibration can be directly obtained.

In the above embodiment, in response to the initial calibration of the sensor, the camera is calibrated to obtain the first intrinsic parameter of the camera, and in response to the sensor being calibrated again, the first intrinsic parameter of the camera obtained by the initial calibration of the sensor can be directly obtained. In this way, the calibration process of the intrinsic parameter of the camera and the calibration process of the target extrinsic parameter between the radar and the camera can be separated. Moreover, in the process of calibrating the sensor again, the sensor can be directly calibrated based on the first intrinsic parameter of the camera which was obtained by the initial calibration of the sensor. There is no need to repeatedly calibrate the intrinsic parameter of the camera, thereby effectively improving the speed of determining the target extrinsic parameter.

In some optional embodiments, when the sensor is initially calibrated, the second calibration plate should be disposed within the range of the field of view of the camera, and a complete second calibration plate can be included in a second image, as shown in FIG. 6, for example. In order to improve the accuracy of the first intrinsic parameter of the camera in the initial calibration, the second calibration plate 620 may be located at the edge of the camera field of view 611 of the camera 610.

For example, as shown in FIG. 7, the above step 100 may include the following steps.

In step 100-1, a plurality of second images are collected by the camera.

Here, position-orientation information of the second calibration plate in respective position-orientations in the plurality of second images is different.

The second calibration plate may be the same as or different from the first calibration plate. In the embodiment of the present disclosure, the first calibration plate being the same as the second calibration plate may mean that the same calibration plate can be used to realize functions of both the first calibration plate and the second calibration plate. When the same calibration plate serves as the second calibration plate, the position-orientation of the same calibration plate can be taken as the position-orientations of the first calibration plate, in addition, the position-orientations different from those of the same calibration plate can also be taken as the position-orientations of the first calibration plate. The first calibration plate being different from the second calibration plate may mean that completely different or partially different calibration plates are used to respectively realize the functions of the first calibration plate and the second calibration plate. The position-orientation information may include the orientation of the second calibration plate in a three-dimensional space, for example, the orientation changes in three dimensions of the pitch angle, the roll angle, and the yaw angle.

In the process of capturing the second images by the camera, the second calibration plate should be in a static state. A bracket can be used to fix the second calibration plate.

When the second images are collected by the camera, in order to improve the accuracy of the first intrinsic parameter, the second calibration plate is made as close as possible to the edge of the field of view of the camera, so that, the ratio of the second calibration plate occupied in a second image among the plurality of second images collected by the camera is greater than a preset value. Optionally, the preset value may be a specific numerical value or a range value. Taking the preset value being a range value as an example, the range value of the preset value will affect the accuracy of each first intrinsic parameter of the camera. Therefore, in order to improve the accuracy of the first intrinsic parameter of the camera determined subsequently, the preset value may be set to a value between [0.8, 1]. For example, in the image shown in FIG. 8, the ratio of the second calibration plate in the entire image is within a range of the preset value, so this image can be taken as the second image.

In order to improve the accuracy of the determined first intrinsic parameter of the camera, the number of the second images collected by the camera may be multiple, for example, more than 20. In the embodiment of the present disclosure, the position-orientations of the second calibration plate in the collected plurality of second images may be different, that is, there are at least some images in the plurality of second images that respectively show the different position-orientations of the second calibration plate, for example, there are orientation changes in three dimensions of a pitch angle, a roll angle, and a yaw angle. This means that the plurality of second images can be collected when the second calibration plate is in different positions and/or orientations, that is, the position-orientation information of the second calibration plate included in different second images may be same or different, and there are at least two second images including different position-orientation information of the second calibration plate. Here, each second image needs to include a complete second calibration plate.

Here, the number of second images may be c, and the number of position-orientations of the second calibration plate may be d, and both c and d are integers greater than or equal to 2. The number c may be equal to the aforementioned number m of the first images, or may not equal to m, similarly, d may be equal to the aforementioned number n of the position-orientations of the second calibration plate, or may not equal to n.

In order to improve the accuracy of the first intrinsic parameter of the camera, the plurality of second images collected by the camera should not have image blurring, wherein the image blurring may be caused by movement of the sensor, that is, relative movement between the camera and the second calibration plate caused by the movement of the camera. Optionally, it can be determined whether there are motion-blurred images in the plurality of second images collected by the camera, and the motion-blurred images can be removed. Alternatively, the motion-blurred images can be filtered out through a preset script.

In step 100-2, a plurality of first candidate intrinsic parameters of the camera are respectively determined according to the plurality of second images, and a respective one of the plurality of first candidate intrinsic parameters is determined as the first intrinsic parameter.

In the embodiment of the present disclosure, a preset matlab toolbox can be used to respectively calibrate the plurality of first candidate intrinsic parameters of the camera. according to the plurality of second images.

For each of the plurality of first candidate intrinsic parameters, a preset point located in the camera coordinate system can be re-projected into the pixel coordinate system by the camera, so as to obtain a corresponding projection point, and then an error value of the preset point can be obtained by calculating an error between the projection point and the corresponding preset point in the pixel coordinate system. The error values respectively obtained by the first candidate intrinsic parameters are compared, and a first candidate intrinsic parameter with the smallest error value is taken as the first intrinsic parameter of the camera.

The above steps 100-1 and 100-2 are the process of calibrating the first intrinsic parameter of the camera in the case of the initial calibration of the sensor, and there is no limitation on the order of execution with step 101. If the sensor is calibrated again, the first intrinsic parameter of the camera calibrated in advance can be directly obtained.

In the embodiment of the present disclosure, the first candidate intrinsic parameters of the camera are the plurality of first candidate intrinsic parameters of the camera respectively determined according to the plurality of second images collected by the camera which include the second calibration plate with different position-orientation information. Among the first candidate intrinsic parameters, the first candidate intrinsic parameter with the smallest error value between the projection point and the corresponding preset point in the pixel coordinate system determined in the above manner is selected as the first intrinsic parameter of the camera.

In the above embodiment, a plurality of first candidate intrinsic parameters of the camera can be determined, so that one of the plurality of first candidate intrinsic parameters is determined as the first intrinsic parameter, thereby improving the accuracy and precision of determining the intrinsic parameter of the camera, and having high usability.

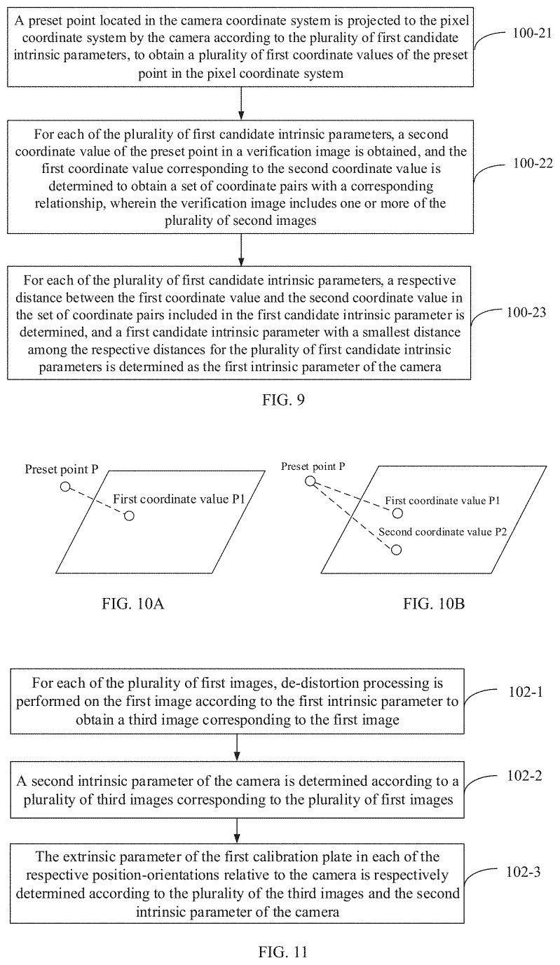

In some optional embodiments, for example, as shown in FIG. 9, step 100-2 may include the following steps.

In step 100-21, a preset point located in the camera coordinate system is projected to the pixel coordinate system by the camera according to the plurality of first candidate intrinsic parameters, to obtain a plurality of first coordinate values of the preset point in the pixel coordinate system.

The number of preset points can be one or more. For each preset point, different first candidate intrinsic parameters can be used by the camera to project the preset point located in the camera coordinate system into the pixel coordinate system, so as to obtain the plurality of first coordinate values of each preset point in the pixel coordinate system.

For example, as shown in FIG. 10A, a preset point P in the 3D space is projected into the 2D space to obtain the corresponding first coordinate value P1.

In step 100-22, for each of the plurality of first candidate intrinsic parameters, a second coordinate value of the preset point in a verification image is obtained, and the first coordinate value corresponding to the second coordinate value is determined to obtain a set of coordinate pairs with a corresponding relationship, wherein the verification image includes one or more of the plurality of second images.

For each first candidate intrinsic parameter, the second coordinate value of the preset point in the pixel coordinate system can be determined. For example, the second coordinate value shown in FIG. 10B is P2, and the first coordinate value P1 corresponding to the second coordinate value P2 is determined. For respective first candidate intrinsic parameters, the multiple sets of coordinate pairs with corresponding relationships can be obtained. For example, for the first candidate intrinsic parameter, P2 corresponds to P1, and P1 and P2 constitute a set of coordinate pairs. For another example, for a second candidate intrinsic parameter, P2′ corresponds to P1′, and P1′ and P2′ constitute another set of coordinate pairs.

When the verification image is a plurality of second images, for a first candidate intrinsic parameter i, a second coordinate value of a preset point on a verification image j and a first coordinate value corresponding to the second coordinate value can be obtained to constitute a set of coordinate pairs Pⱼⁱ, and then multiple sets of coordinate pairs P1ⁱ, P₂ⁱ, P₃ⁱ, . . . of the preset point on the plurality of verification images are obtained, which can be recorded as Pⁱ.

In step 100-23, for each of the plurality of first candidate intrinsic parameters, a respective distance between the first coordinate value and the second coordinate value in the set of coordinate pairs included in the first candidate intrinsic parameter is determined, and a first candidate intrinsic parameter with a smallest distance among the respective distances for the plurality of first candidate intrinsic parameters is determined as the first intrinsic parameter of the camera.

In the embodiment of the present disclosure, the distance between the first coordinate value and the second coordinate value in each set of coordinate pairs can be calculated separately. A first candidate intrinsic parameter corresponding to the smallest distance can be taken as the first intrinsic parameter of the camera.

Assuming that the distances among the first coordinate values and the second coordinate values are d1, d2 and d3, respectively, wherein d2 is the smallest and d2 corresponds to the first candidate intrinsic parameter 2, and the first candidate intrinsic parameter 2 can be determined as the first intrinsic parameter of the camera.

When the first candidate intrinsic parameter i includes a plurality of coordinate pairs, the distance of each coordinate pair in Pⁱ can be calculated separately, and then the total distance of the plurality of coordinate pairs can be obtained, for example, the distances of each coordinate pair can be added up to obtain the total distance. The total distances of the first candidate parameters are compared, and the first candidate intrinsic parameter with the smallest total distance among the plurality of first candidate intrinsic parameters is determined as the first intrinsic parameter of the camera.

For the sake of simplicity, the above description is given based on one preset point. However, those skilled in the art can know that there may be a plurality of preset points. In the case of a plurality of preset points, the method for obtaining the first intrinsic parameter is similar to the case of one preset point. For example, for each first candidate intrinsic parameter, the distance of the coordinate pair for each preset point can be calculated, then the average value of the distances for the plurality of preset points can be calculated, and a first candidate intrinsic parameter with the smallest average value of the distances among the plurality of first candidate intrinsic parameters can be determined as the first intrinsic parameter of the camera.

In the above embodiment, the first candidate intrinsic parameter with the smallest re-projection error is taken as the target intrinsic parameter of the camera, so that the intrinsic parameter of the camera is more accurate.

in some optional embodiments, for example, as shown in FIG. 11, step 102 may include the following steps.

In step 102-1, for each of the plurality of first images, de-distortion processing is performed on the first image according to the first intrinsic parameter to obtain a third image corresponding to the first image.

For example, a device with image processing function (which can be a radar, a camera or other devices) deployed on a machine device equipped with both the radar and the camera, such as a vehicle equipped with both the radar and the camera, can perform de-distortion processing on a plurality of first images.

In the embodiment of the present disclosure, in order to obtain a more accurate extrinsic parameter of the first calibration plate relative to the camera later, the plurality of first images can be de-distorted according to the first intrinsic parameter of the camera calibrated in advance to obtain a plurality of third images; a second intrinsic parameter of the camera can be determined based on the plurality of third images, that is, the intrinsic parameter of the camera under ideal conditions without distortion; and then the extrinsic parameter of the first calibration plate relative to the camera is determined based on the second intrinsic parameter of the camera.

Here, the intrinsic parameter of the camera can be represented by an intrinsic parameter matrix A′, as shown in Equation 1:

$${A}^{′} = [ \begin{matrix}\frac{f}{{S}_{x}} & r & {u}_{0} \\ 0 & \frac{f}{{S}_{y}} & {v}_{0} \\ 0 & 0 & 1\end{matrix} ] \qquad Equation 1$$

wherein the meaning of each parameter can refer to the above description of camera parameter.

The process of performing de-distortion processing on the plurality of first images is to ignore the influence of a distance value r of the pixel from the center of the imager due to distortion in the above intrinsic parameter matrix A′, so that r is as zero as possible. The intrinsic parameter matrix A ignoring the influence of the distortion can be expressed by Equation 2:

$$A = [ \begin{matrix}\frac{f}{{S}_{x}} & 0 & {u}_{0} \\ 0 & \frac{f}{{S}_{y}} & {v}_{0} \\ 0 & 0 & 1\end{matrix} ] \qquad Equation 2$$

In this way, the plurality of third images corresponding to the first images can be obtained.

In step 102-2, a second intrinsic parameter of the camera is determined according to a plurality of third images corresponding to the plurality of first images.

A plurality of second candidate intrinsic parameters of the camera can be respectively determined by a preset matlab toolbox according to the plurality of third images obtained by performing the de-distortion processing. Different second candidate intrinsic parameters are respectively used by the camera to project a preset point located in the camera coordinate system to the pixel coordinate system to obtain a plurality of third coordinate values. A fourth coordinate value of each preset point observed in the pixel coordinate system and the corresponding third coordinate value are taken as a set of coordinate pairs that have a corresponding relationship, and a second candidate intrinsic parameter corresponding to the smallest distance in the plurality of coordinate pairs is taken as the second intrinsic parameter of the camera.

In the embodiment of the present disclosure, the second intrinsic parameter is the intrinsic parameter of the camera determined according to the plurality of third images obtained by performing the de-distortion processing.

The plurality of second candidate intrinsic parameters of the camera are a plurality of intrinsic parameters of the camera determined in an ideal state based on a plurality of third images obtained by performing de-distortion processing on a plurality of first images of the first calibration plate with different position-orientation information collected by the camera. The second intrinsic parameter is the second candidate intrinsic parameter with the smallest error between the projection point determined in the plurality of second candidate intrinsic parameters and the corresponding preset point in the pixel coordinate system. The second intrinsic parameter is the intrinsic parameter of the camera in the ideal state without distortion.

In step 102-3, the extrinsic parameter of the first calibration plate in each of the respective position-orientations relative to the camera is respectively determined according to the plurality of the third images and the second intrinsic parameter of the camera.

A homography matrix H corresponding to each third image can be calculated separately to obtain a plurality of homography matrices and then extrinsic parameters of the first calibration plate in different poses relative to the camera are calculated based on the second intrinsic parameter and the plurality of homography matrices, which may include a rotation matrix R and a translation matrix T.

Here, the homography matrix is a matrix describing a positional mapping relationship between the world coordinate system and the pixel coordinate system.

In the above embodiment, a plurality of first images taken by the camera can be performed the de-distortion processing according to a first intrinsic parameter of the camera to obtain a plurality of third images, and a second intrinsic parameter of the camera can be determined according to the plurality of third images, wherein the second intrinsic parameter is equivalent to the intrinsic parameter of the camera in the ideal state without distortion: and then, an extrinsic parameter of the first calibration plate relative to the camera is determined according to the plurality of third images and the second intrinsic parameter, The extrinsic parameter of the first calibration plate relative to the camera obtained by the above method has higher accuracy.

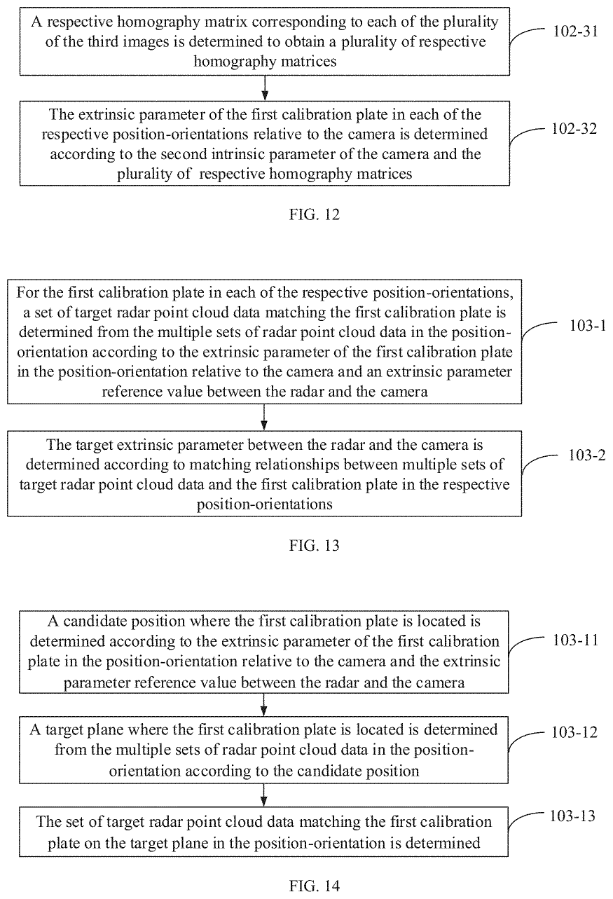

In some optional embodiments, for example, as shown in FIG. 12, the step 102-3 can include the following steps.

In step 102-31, a respective homography matrix corresponding to each of the plurality of the third images is determined to obtain a plurality of respective homography matrices.

In the embodiment of the present disclosure, the homography matrix H corresponding to each third image can be calculated in the following manner:

$$s [ \begin{matrix}u \\ v \\ 1\end{matrix} ] = A [ \begin{matrix}{r}_{1} & {r}_{2} & {r}_{3} & t\end{matrix} ] [ \begin{matrix}X \\ Y \\ 0 \\ 1\end{matrix} ] = A [ \begin{matrix}{r}_{1} & {r}_{2} & t\end{matrix} ] [ \begin{matrix}X \\ Y \\ 1\end{matrix} ] \qquad Equation 3$$

$$H = A [ \begin{matrix}{r}_{1} & {r}_{2} & t\end{matrix} ] \qquad Equation 4$$

wherein r₁, r₂ and r₃ are rotation column vectors that make up the rotation matrix R, the dimension is 1×3, and t is a vector form of the translation matrix T.

According to Equation 3 and Equation 4, Equation 5 can be obtained:

$$s [ \begin{matrix}u \\ v \\ 1\end{matrix} ] = H [ \begin{matrix}X \\ Y \\ 1\end{matrix} ] \qquad Equation 5$$

wherein (u, v) is a pixel coordinate, (X, Y) corresponds to the coordinate of the calibration plate, and s is a scale factor.

In the embodiment of the present disclosure, the homography matrix H corresponding to the plurality of third images can be calculated by Equation 5.

In step 102-32, the extrinsic parameter of the first calibration plate in each of the respective position-orientations relative to the camera is determined according to the second intrinsic parameter of the camera and the plurality of respective homography matrices.

After obtaining a plurality of homography matrices H through calculation, in the case of determining the extrinsic parameters R and T of the first calibration plate in different position-orientation relative to the camera, the above Equation 4 can be used for calculation. Here, the homography matrix H is a 3×3 matrix, and Equation 4 can be further expressed as:

[h₁ h₂ h₃]=λA[r₁ r₂ t] Equation 6

where λ represents a scale factor.

r₁=λA⁻¹h₁, r₂=λA⁻¹h₂, r₃=r₁×r₂ can be obtained through calculation, where λ=1/∥A⁻¹h₃∥=1/∥A⁻¹h₂∥. r1, r2 and r3 constitute a 3×3 rotation matrix R.

According to Equation 6, it can be calculated t=λA⁻¹h₃, where t forms a 3×1 translation matrix T.

In the above embodiment, the homography matrix corresponding to each third image can be determined separately, and according to the plurality of obtained homography matrices and the second intrinsic parameter of the camera, an extrinsic parameter of the first calibration plate in each of the respective position-orientations relative to the camera is determined, so that the extrinsic parameter of the first calibration plate relative to the camera can be more accurate.

In some optional embodiments, for example, as shown in FIG. 13, the foregoing step 103 can include the following steps.

In step 103-1, for the first calibration plate in each of the respective position-orientations, a set of target radar point cloud data matching the first calibration plate is determined from the multiple sets of radar point cloud data in the position-orientation according to the extrinsic parameter of the first calibration plate in the position-orientation relative to the camera and an extrinsic parameter reference value between the radar and the camera.

Here, the extrinsic parameter reference value can be a rough estimated extrinsic parameter value between the radar and the camera based on an approximate position and orientation between the radar and the camera. The radar coordinate system and the camera coordinate system can be superimposed according to the extrinsic parameter reference value and unified into the camera coordinate system.

In the embodiment of the present disclosure, for the first calibration plate in each position-orientation, a target plane where the first calibration plate is located can be determined with a M-estimator SAmple Consensus (MSAC) algorithm according to the extrinsic parameter of the first calibration plate relative to the camera and the extrinsic parameter reference value between the radar and the camera. Further, a MeanShift (MeanShift) clustering algorithm can be used on the target plane to determine the target radar point cloud data matching the first calibration plate from the corresponding radar point cloud data.

In step 103-2, the target extrinsic parameter between the radar and the camera is determined according to matching relationships between multiple sets of target radar point cloud data and the first calibration plate in the respective position-orientations.

In the embodiment of the present disclosure, there is only one position-orientation from the radar to the camera. However, when determining the target extrinsic parameter between the radar and the camera, there are a plurality of position-orientations for the first calibration plate, such as a number n of position-orientations. Therefore, in step 103-1, n sets of target radar point cloud data can be obtained. The n sets of target radar point cloud data can be matched respectively with the first calibration plate in the n position-orientations to obtain n matching relationships. Then, the extrinsic parameters between the radar and the camera can be calculated through the n matching relationships.

In the embodiment of the present disclosure, based on the matching relationships among the multiple sets of target radar point cloud data and the first calibration plate, the target extrinsic parameter between the radar and the camera can be determined by using a least square method.

In the above embodiment, for the first calibration plate in each position-orientation, a target plane where the first calibration plate is located can be determined with an M estimation algorithm based on the extrinsic parameter of the first calibration plate relative to the camera, and the extrinsic parameter reference value between the radar and the camera. Further, a mean shift clustering algorithm is used to determine a set of target radar point cloud data matching the first calibration plate in the corresponding radar point cloud data on the target plane. The target radar point cloud data matching the first calibration plate is automatically determined from the radar point cloud data, which can reduce the matching error and improve the accuracy of the point cloud matching. According to the matching relationship between the multiple sets of target radar point cloud data and the first calibration plate, the target extrinsic parameter between the radar and the camera is determined, which can quickly determine the target extrinsic parameter between the radar and the camera, and improve the accuracy of the target extrinsic parameter.

In some optional embodiments, for example, as shown in FIG. 14, for the first calibration plate in a certain position-orientation, the above step 103-1 can include the following steps.

In step 103-11, a candidate position where the first calibration plate is located is determined according to the extrinsic parameter of the first calibration plate in the position-orientation relative to the camera and the extrinsic parameter reference value between the radar and the camera.

In the embodiment of the present disclosure, the position where the first calibration plate is located is estimated in the radar point cloud data collected for the first calibration plate, according to the extrinsic parameter of the first calibration plate in the position-orientation relative to the camera and the estimated extrinsic parameter reference value between the radar and the camera, to obtain an approximate position-orientation of the first calibration plate. The approximate position-orientation where the first calibration plate is located is taken as a candidate position. The candidate position represents the approximate position of the first calibration plate in a map composed of radar point cloud data.

In step 103-12, a target plane where the first calibration plate is located is determined from the multiple sets of radar point cloud data in the position-orientation according to the candidate position.

In the embodiment of the present disclosure, from a set of radar point cloud data collected in the position-orientation, the plurality of first radar points located in the area corresponding to the candidate position can be randomly selected, and a first plane composed. of the plurality of radar points can be obtained. Such selection is repeated for several times to obtain a plurality of first planes.

For each of the plurality of first plane, distances from other radar points in the set of radar point cloud data than the first radar point to the first plane are respectively calculated. Radar points having a distance less than a preset threshold among other radar points are taken as the second radar points, and the second radar points are determined as the radar points in the first plane. The first plane with the largest number of radar points is taken as the target plane where the first calibration plate is located. The target plane represents the plane on which the first calibration plate is located in a map composed of radar point cloud data.

In step 103-13, the set of target radar point cloud data matching the first calibration plate on the target plane in the position-orientation is determined.

On each target plane, a first circular area is randomly determined according to the size of the first calibration plate. The initial first circular area can be the area corresponding to the circumscribed circle of the first calibration plate. In each set of the radar point cloud data, any radar point located in the initial first circular area is randomly selected as a first center of the first circular area to adjust the position of the first circular area in the in the radar point cloud data. Here, the size of the first calibration plate is the size of the first calibration plate in a map composed of radar point cloud data.

Taking the first circle center as the starting point, and a plurality of third radar points located in the first circular area in the radar point cloud data as ending points, a plurality of first vectors are obtained respectively. A second vector is obtained by adding the plurality of first vectors. Based on the second vector, a target center position of the first calibration plate is determined. Here, the target center position of the first calibration plate is the determined center position of the first calibration plate in a map composed of radar point cloud data.

Further, according to the target center position of the first calibration plate and the size of the first calibration plate, a set of target radar point cloud data matching the first calibration plate is determined in the radar point cloud data,

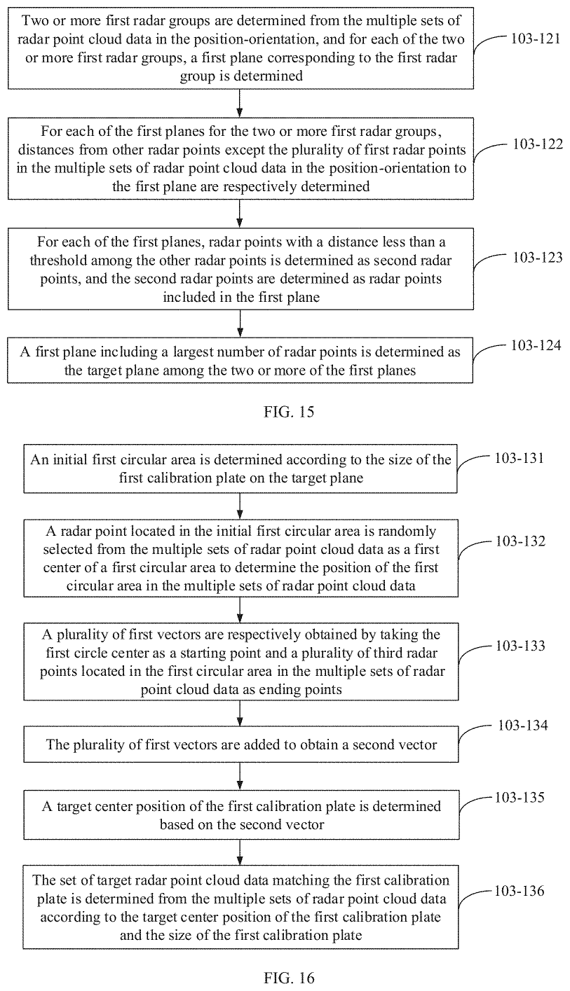

In some optional embodiments, for example, as shown in FIG. 15, steps 103-12 can include the following steps.

In step 103-121, two or more first radar groups are determined from the multiple sets of radar point cloud data in the position-orientation, and for each of the two or more first radar groups, a first plane corresponding to the first radar group is determined, where the first radar group includes a plurality of first radar points randomly selected and located in an area corresponding to the candidate position, and the first plane corresponding to the first radar group includes a plurality of first radar points of the first radar group.

In the embodiment of the present disclosure, a plurality of first radar points located in the area corresponding to the candidate position can be randomly selected from the radar point cloud data corresponding to a certain position-orientation each time to obtain a first radar group, and then a first plane composed of a plurality of first radar points of the first radar group can be obtained each time. If the plurality of first radar points are randomly selected in a plurality of times, a plurality of first planes can be obtained.

For example, assuming that the radar points include 1, 2, 3, 4, 5, 6, 7 and 8, the first radar points 1, 2, 3, and 4 are randomly selected to form a first plane 1 for the first time, and the first radar points 1, 2, 4, and 6 are randomly selected to form a first plane 2 for the second time, and the first radar points 2, 6, 7 and 8 are randomly selected to form a first plane 3 for the third time.

In step 103-122, for each of the first planes for the two or more first radar groups, distances from other radar points except the plurality of first radar points in the multiple sets of radar point cloud data in the position-orientation to the first plane are respectively determined.

For example, for the first plane 1, the distances from other radar points 5, 6, 7, and 8 to the first plane 1 can be calculated; for the first plane 2, the distances from other radar points 3, 5, 7, and 8 to the first plane 2 can be calculated; and similarly, for the first plane 3, the distances from other radar points 1, 3, 4, and 5 to the first plane 3 can be calculated.

In step 103-123, for each of the first planes, radar points with a distance less than a threshold among the other radar points is determined as second radar points, and the second radar points are determined as radar points included in the first plane.

For example, assuming that for the first plane the distance from other radar point 5 to the first plane 1 is less than the preset threshold, then radar point 5 is taken as the second radar point, and finally the first plane 1 includes radar point 1, 2, 3, 4, and 5. Similarly, it can be assumed that the first plane 2 includes radar points 1, 2, 4, 6, and 7, and it can be assumed that the first plane 3 includes radar points 1, 3, 4, 5, 6, 8.

In step 103-124, a first plane including a largest number of radar points is determined as the target plane among the two or more of the first planes.

A first plane with the largest number of radar points, such as the first plane 3, is determined as the target plane where the first calibration plate is located,

The above method can be used to determine a target plane where the first calibration plate in a certain position-orientation is located for each set of radar point cloud data. The fitted target plane is more accurate and highly usable.

In some optional embodiments, for example, as shown in FIG. 16, steps 103-13 can include the following steps.

In step 103-131, an initial first circular area is determined according to the size of the first calibration plate on the target plane.

In the embodiment of the present disclosure, after the target plane where the first calibration plate is located is determined, the initial first circular area can be determined on the target plane according, to the size of the first calibration plate. The size can be the size of the circumscribed circle of the first calibration plate. Here, the size of the first calibration plate is the size of the first calibration plate in the map composed of radar point cloud data.

In step 103-132, a radar point located in the initial first circular area is randomly selected from the multiple sets of radar point cloud data as a first center of a first circular area to determine the position of the first circular area in the multiple sets of radar point cloud data.

In the embodiment of the present disclosure, after the initial first circular area is determined, a radar point is randomly selected from the radar point cloud data in the initial first circular area as the first circle center of the first circular area. The position of the first circular area in the radar point cloud data is subsequently adjusted through the first circle center. The radius of the first circular area is the same as that of the initial first circular area.

In step 103-133, a plurality of first vectors are respectively obtained by taking the first circle center as a starting point and a plurality of third radar points located in the first circular area in the multiple sets of radar point cloud data as ending points.

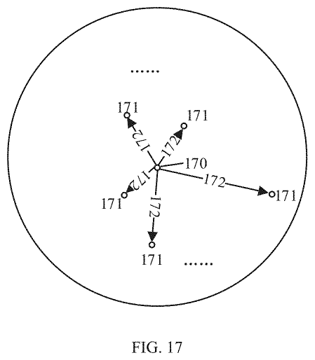

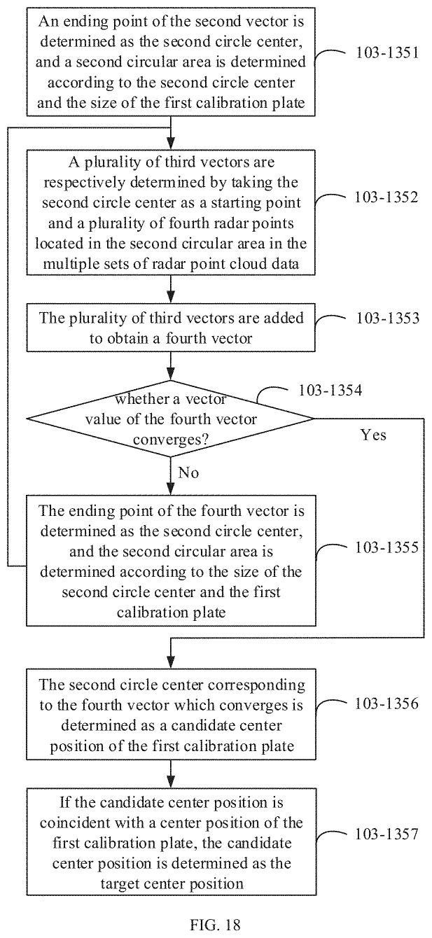

In the embodiment of the present disclosure, as shown in FIG. 17, for example, the first circle center 170 can be taken as the starting point, and the plurality of third radar points 171 located in the first circular area in the radar point cloud data can be taken as the ending points, so that the plurality of first vectors 172 can be obtained.

In some examples, the third radar points 171 can effectively cover a circular area, as shown in FIG. 17.

In step 103-134, the plurality of first vectors are added to obtain a second vector.

In the embodiment of the present disclosure, a Meanshift vector, that is, a second vector, can be obtained by adding all the first vectors.

In step 103-135, a target center position of the first calibration plate is determined based on the second vector.

In the embodiment of the present disclosure, the ending point of the second vector is taken as the second circle center, and the second circular area is obtained according to the size of the first calibration plate. A plurality of fourth radar points in the second circular area are taken as the ending points and the second circle center is taken as the starting point, a plurality of third vectors are obtained respectively. The plurality of third vectors are added to obtain a fourth vector, and then the ending point of the fourth vector is taken as a new second circle center to obtain a new second circular area. The above steps are repeated to determine the fourth vector until the fourth vector converges to a preset value, and the corresponding second circle center at this time is taken as the candidate center position of the first calibration plate. The candidate center position is the candidate center position of the first calibration plate in the map composed of the radar point cloud data.

It can be determined whether the candidate center position coincides with the center position of the first calibration plate. If the candidate center position coincides with the center position of the first calibration plate, the candidate center position can be directly taken as the target center position; otherwise, the new candidate center position can be re-determined until the final target center position is determined.

In step 103-136, the set of target radar point cloud data matching the first calibration plate is determined from the multiple sets of radar point cloud data according to the target center position of the first calibration plate and the size of the first calibration plate.

In the embodiment of the present disclosure, after the target center position of the first calibration plate is determined, the corresponding position of the first calibration plate can be determined according to the target center position and size of the first calibration plate. A calibration plate matches the actual first calibration plate in the position-orientation, so that the radar point cloud data matching the position of the first calibration plate in the radar point cloud data can be taken as the target radar point cloud data.

In some optional embodiments, for example, as shown in 18, steps 103-135 can include the following steps.

In step 103-1351, an ending point of the second vector is determined as the second circle center, and a second circular area is determined according to the second circle center and the size of the first calibration plate.

In the embodiment of the present disclosure, the ending point of the second vector can be determined as the second circle center, and then the second circle center can be taken as the new circle center, and the radius is the radius of the circumscribed circle of the first calibration plate to obtain the second circular area.

In step 103-1352 a plurality of third vectors are respectively determined by taking the second circle center as a starting point and a plurality of fourth radar points located in the second circular area in the multiple sets of radar point cloud data.

In the embodiment of the present disclosure, the second circle center is taken as the starting point, and the plurality of fourth radar points located in the second circle center area in the radar point cloud data are taken as the ending points, so that the plurality of third vectors are obtained respectively.

In step 103-1353, the plurality of third vectors are added to obtain a fourth vector.

In step 103-1354, it is determined whether a vector value of the fourth vector converges to a preset value.

If the vector value of the fourth vector converges to the preset value, jump to step 103-1356; and if the vector value of the fourth vector does not converge to the preset value, jump to step 103-1355. Alternatively, the preset value can be close to zero.

In step 103-1355, the ending point of the fourth vector is determined as the second circle center, and the second circular area is determined according to the size of the second circle center and the first calibration plate, and then jump to step 103-1352,

In the embodiment of the present disclosure, the ending point of the fourth vector can be redetermined as the new second circle center, and a new fourth vector can be calculated again according to the above steps 103-1352 to 103-1354, and it can be determined whether the vector value of the fourth vector is converged. The above process is repeated continuously until the finally obtained vector value of the four vector converges to the preset value.

In step 103-1356, the second circle center corresponding to the fourth vector which converges is determined as a candidate center position of the first calibration plate.

In the embodiment of the present disclosure, in the case that the vector value of the fourth vector converges to the preset value, the second circle center corresponding to the fourth vector can be taken as a candidate center position of the first calibration plate.

In step 103-1357, if the candidate center position is coincident with a center position of the first calibration plate, the candidate center position is determined as the target center position.

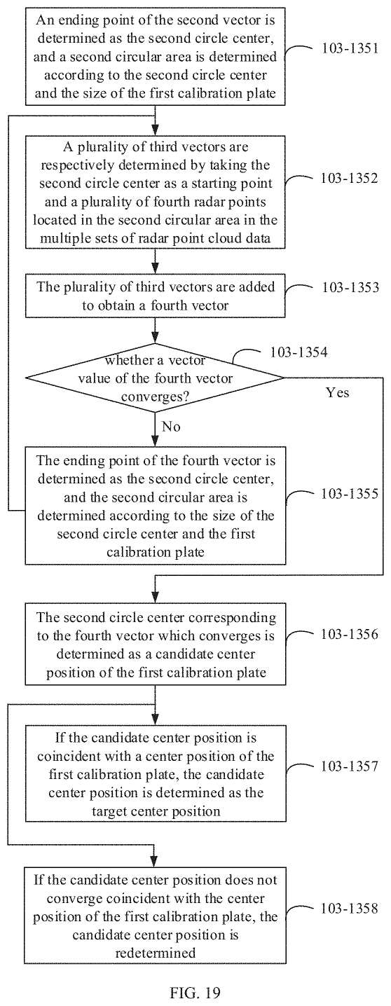

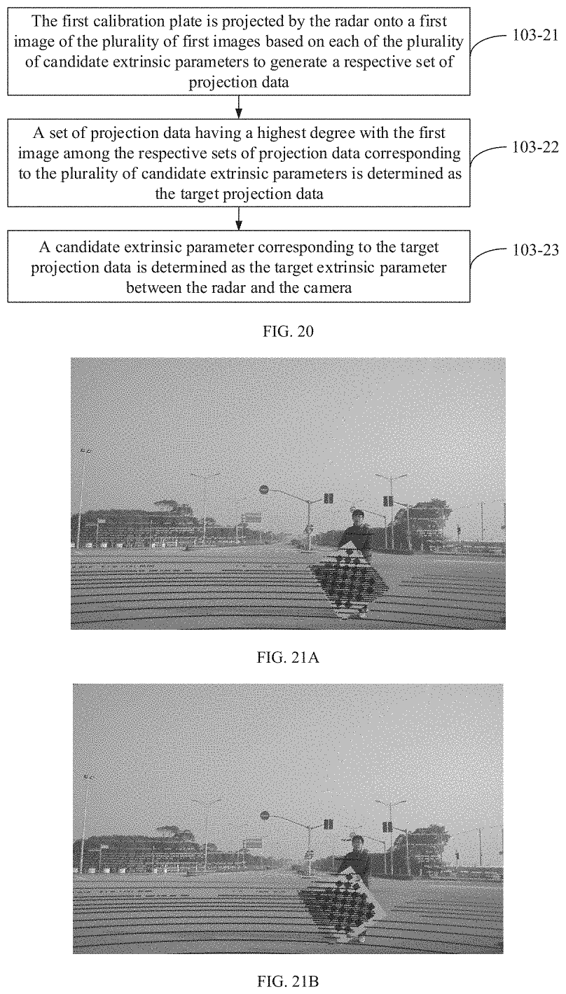

In the embodiment of the present disclosure, it can be determined whether the candidate center position overlaps with the center position of the first calibration plate in the map composed of radar point cloud data; and if the candidate center position overlaps with the center position of the first calibration plate, the candidate center position can be directly taken as the final target center position of the first calibration plate. In some optional embodiments, for example, as shown in FIG. 19, step 103-135 can further include the following steps.

In step 103-1358, if the candidate center position does not converge coincident with the center position of the first calibration plate, the candidate center position is redetermined.

In the case that the candidate center position does not coincide with the center position of the first calibration plate, all radar points in the second circular area can be deleted, and a new second circular area can be redetermined. Alternatively, the set of radar point cloud data is directly deleted and the candidate center position of the first calibration plate is redetermined according to another set of radar point cloud data corresponding to other attitudes of the first calibration plate until the determined candidate center position coincides with the center position of the first calibration plate.

At this time, step 103-1357 is performed again, and the candidate center position is determined as the target center position corresponding to the current target attitude of the first calibration plate.

In some optional embodiments, step 103-2 can include: a candidate extrinsic parameter between the radar and the camera is determined according to g matching relationships, and the target extrinsic parameter between the radar and the camera is determined according to a plurality of the candidate extrinsic parameters.

In the embodiment of the present disclosure, a candidate extrinsic parameter can be determined by using the least square method, that is, by minimizing the sum of squares of the extrinsic parameter errors between the radar and the camera, according to the g matching relationships, where g is an integer greater than or equal to 3.

For example, a first calibration plate with position-orientation information 1 corresponds to target radar point cloud data 1, a first calibration plate with position-orientation information 2 corresponds to target radar point cloud data 2, and so on, there are n sets of matching relationships. A candidate extrinsic parameter 1 can be determined based on previous three sets of the matching relationships, a candidate extrinsic parameter 2 can be determined based on previous four sets of the matching relationships, and a candidate extrinsic parameter 3 can be determined based on the matching relationships between the previous two sets and the fourth set, and so on, a plurality of extrinsic parameters can be determined.

Among the plurality of candidate extrinsic parameters determined above, a candidate extrinsic parameter with the best projection effect is determined as the target extrinsic parameter between the radar and the camera.

In the above embodiment, the candidate extrinsic parameters between the radar and the camera can be determined based on the plurality of matching relationships, and a candidate extrinsic parameter with the best projection effect is selected according to the plurality of candidate extrinsic parameters as the target extrinsic parameter between the radar and the camera, thereby improving the accuracy of the target extrinsic parameter between the radar and the camera.

In some optional embodiments, for example, as shown in 20, step 103 can further include the following steps.

In step 103-21. the first calibration plate is projected by the radar onto a first image of the plurality of first images based on each of the plurality of candidate extrinsic parameters to generate a respective set of projection data.

In the camera coordinate system, the candidate extrinsic parameter between the radar and the camera, the matrix of the intrinsic parameter of the camera and the radar point cloud data can be multiplied to project the radar point cloud data to a certain first image, and then a set of projection data can be obtained, for example, as shown in FIG. 21A. The radar point cloud data can be a set of the multiple sets of radar point cloud data collected before, or can be radar point cloud data newly collected. For better subsequent comparison, the first calibration plate needs to be included in the collected target.

In step 103-22, a set of projection data having a highest degree with the first image among the respective sets of projection data corresponding to the plurality of candidate extrinsic parameters is determined as the target projection data.

Among the multiple sets of projection data, a set of projection data having the highest degree with the first image is determined, and then the set of projection data is determined as target projection data. For example, the two sets of projection data are respectively projected on the first image to obtain the projection data, for example, as shown in FIG. 21A and FIG. 21B, wherein the projection effect of FIG. 21A is better than that of FIG. 21B, and thus the projection data corresponding to FIG. 21A is the target projection data.

In step 103-23, a candidate extrinsic parameter corresponding to the target projection data is determined as the target extrinsic parameter between the radar and the camera.

A candidate extrinsic parameter corresponding to the target projection data is the target extrinsic parameter between the radar and the camera.

In the above embodiment, the plurality of candidate extrinsic parameters can be verified according to the projection effect, and the candidate extrinsic parameter with the best projection effect is determined as the final target extrinsic parameter, thereby improving the accuracy of the target extrinsic parameter between the radar and the camera.

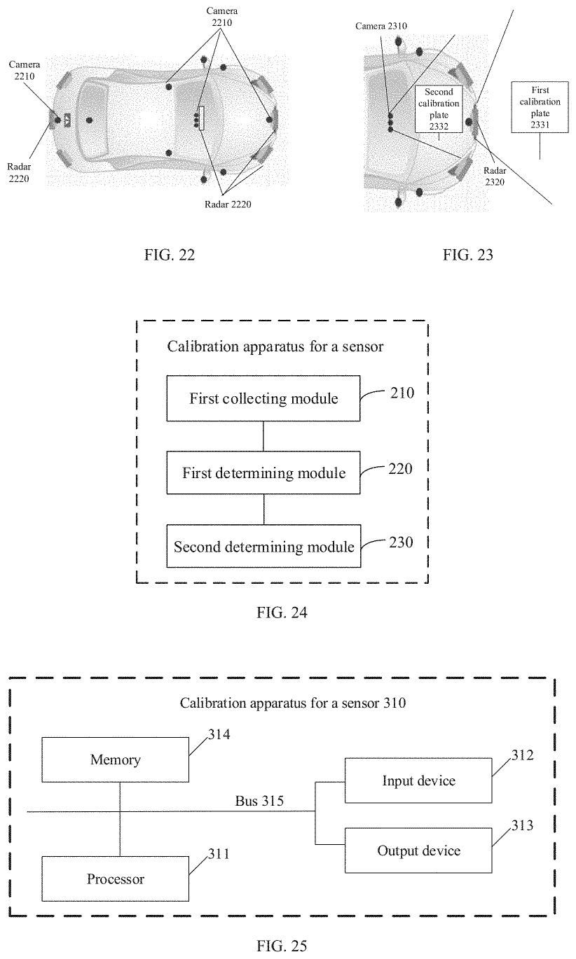

In some optional embodiments, the radar and the camera can be deployed on a. vehicle, and the radar can be a lidar. Optionally, the radar and the camera can be deployed at different positions of the vehicle. For example, as shown in FIG. 22, a radar 2220 and a camera 2210 can be deployed in the front and the rear of the vehicle, the front windshield, etc. After the first intrinsic parameter of the camera 2210 is determined, if the target extrinsic parameter between the radar 2220 and the camera 2210 is to be redetermined, the previously calibrated first intrinsic parameter can be directly obtained to quickly determine the target extrinsic parameter, thereby improving accuracy of the target extrinsic parameter between the radar 2220 and camera 2210.

The above-mentioned methods provided by the embodiment of the present disclosure can be used on a machinery device, which can be manually driven or unmanned vehicles, such as airplanes, vehicles, drones, unmanned vehicles, and robots, etc. Taking a vehicle as an example, the two sensors, the radar and the camera, can be set above the center console, close to the front windshield glass. Due to the movement of the vehicle, the attitude of at least one of the radar and the camera will change. At this time, the extrinsic parameter between the radar and the camera need to be recalibrated. Due to the influence of the front windshield on the refraction of light, the intrinsic parameter of the originally calibrated camera will be inaccurate in the application process, thereby affecting the accuracy of the extrinsic parameter between the radar and the camera.

In the embodiment of the present disclosure, the extrinsic parameter of the first calibration plate with different position-orientation information relative to the camera can be determined directly based on the first intrinsic parameter of the camera calibrated in advance and the plurality of first images collected by the camera; the multiple sets of radar point cloud data of the first calibration plate with different position information are obtained; and finally, the target extrinsic parameter between the lidar and the camera is determined according to the extrinsic parameters of the first calibration plate with the different position-orientation information relative to the camera and the multiple sets of radar point cloud data. Therefore, the target extrinsic parameter between the lidar and the camera can be quickly calibrated, and has high availability.

In some optional embodiments, the radar is deployed on a front bumper of the vehicle, and the camera is deployed at a rearview mirror of the vehicle. For example, as shown in FIG. 23, the first calibration plate 2331 is located within the common field of view range of the radar 2320 and the camera 2310, and the first calibration plate can be fixed on the ground or held by the staff.

If the camera 2310 is being calibrated for the first intrinsic parameter, a plurality of first images containing the first calibration plate 2331 is used. Since the radar 2320 and the camera 2310 are not on the same horizontal plane, the camera 2310 is farther away from the ground. The first calibration plate 2331 in the first images can only occupy part of the content of the first image. In this case, the accuracy of the intrinsic parameter of the camera 2310 calibrated according to the plurality of first images is poor.

In the embodiment of the present disclosure, the intrinsic parameter of the camera can be calibrated through a second calibration plate 2332 located within the field of view range of the camera 2310 and at a relatively short distance from the camera 2310. The horizontal distance between the second calibration plate 2332 and the camera 2310 is less than the horizontal distance between the first calibration plate 2331 and the camera 2310. The second calibration plate 2332 can be fixed on the vehicle. At this time, the collected second image can include a complete second calibration plate, 2332, and then a more accurate first intrinsic parameter of the camera 2310 can be obtained.

In the above embodiment, both the camera 2310 and the radar 2320 are deployed on the vehicle, the distance between the camera 2310 and the ground is greater than the distance between the radar 2320 and the ground, and the horizontal distance between the second calibration plate 2332 and the camera 2310 is less than the horizontal distance between the first calibration plate 2331 and the camera 2310. The plurality of second images collected by the camera 2310 include the complete second calibration plate 2332, which can improve the accuracy of the intrinsic parameter of the calibration camera.

Corresponding to the above method embodiments, the present disclosure also provides device embodiments.

As shown in FIG. 24, FIG. 24 is a block diagram showing a calibration apparatus for a sensor according to an exemplary embodiment of the present disclosure. A first calibration plate is located within a common field of view range of a radar and a camera, and the calibration apparatus includes: a first collecting module 210 configured to collect a plurality of first images by the camera, wherein position-orientation information of the first calibration plate in respective position-orientations in the plurality of first images is different; a first determining module 220 configured to obtain a first intrinsic parameter of the camera calibrated in advance, and respectively determine an extrinsic parameter of the first calibration plate in each of the respective position-orientations relative to the camera according to the first intrinsic parameter and the plurality of first images; and a second determining module 230 configured to multiple sets of radar point cloud data of the first calibration plate in the respective position-orientations, and determine a target extrinsic parameter between the radar and the camera according to the extrinsic parameter of the first calibration plate in each of the respective position-orientations relative to the camera and the multiple sets of radar point cloud data.

In some optional embodiments, the calibration apparatus further includes: a calibration module configured to, in response to determining that an initial calibration of the sensor is being performed for a first time, calibrate the camera to obtain the first intrinsic parameter of the camera. The first determining module includes an obtaining sub-module configured to, in response to calibrating the sensor again, obtain the first intrinsic parameter of the camera obtained by the initial calibration of the sensor.

In some optional embodiments, a second calibration plate is located within a field of view range of the camera, and the calibration module includes: a collecting sub-module configured to collect a plurality of second images by the camera, wherein position-orientation information of the second calibration plate in the plurality of second images is different; a first determining sub-module configured to respectively determine a plurality of first candidate intrinsic parameters of the camera according to the plurality of second images, and determine one of the plurality of first candidate intrinsic parameters as the first intrinsic parameter, wherein each of the plurality of second images corresponds to a respective one of the plurality of first candidate intrinsic parameters.

In some optional embodiments, the first determining sub-module includes: a projection unit configured to project, by the camera, a preset point located in a camera coordinate system to a pixel coordinate system according to the plurality of first candidate intrinsic parameters, to obtain a plurality of first coordinate values of the preset point in the pixel coordinate system; a first determining unit configured to, for each of the plurality of first candidate intrinsic parameters, obtain a second coordinate value of the preset point in a verification image, and determining a first coordinate value corresponding to the second coordinate value to obtain a set of coordinate pairs with a corresponding relationship, wherein the verification image includes one or more of the plurality of second images; and a second determining unit configured to, for each of the plurality of first candidate intrinsic parameters, determine a respective distance between the first coordinate value and the second coordinate value in the set of coordinate pairs included in the first candidate intrinsic parameter, and determine a first candidate intrinsic parameter with a smallest distance among the respective distances for the plurality of first candidate intrinsic parameters as the first intrinsic parameter of the camera.

In some optional embodiments, the first determining module includes: a de-distortion sub-module configured to, for each of the plurality of first images, perform de-distortion processing on the first image according to the first intrinsic parameter to obtain a third image corresponding to the first image; a second determining sub-module configured to determine a second intrinsic parameter of the camera according to a plurality of third images corresponding to the plurality of first images; and a third determining sub-module configured to respectively determine the extrinsic parameter of the first calibration plate in each of the respective position-orientations relative to the camera according to the plurality of the third images and the second intrinsic parameter of the camera.

In some optional embodiments, the third determining sub-module includes: a third determining unit configured to determine a respective homography matrix corresponding to each of the plurality of the third images to obtain a plurality of respective homography matrices; and a fourth determining unit configured to determine the extrinsic parameter of the first calibration plate in each of the respective position-orientations relative to the camera according to the second intrinsic parameter of the camera and the plurality of respective homography matrices.

In some optional embodiments, the second determining module includes: a fourth determining sub-module configured to, for the first calibration plate in each of the respective position-orientations, determine a set of target radar point cloud data matching the first calibration plate from the multiple sets of radar point cloud data in the position-orientation according to the extrinsic parameter of the first calibration plate in the position-orientation relative to the camera and an extrinsic parameter reference value between the radar and the camera; and a fifth determining sub-module configured to determine the target extrinsic parameter between the radar and the camera according to matching relationships between multiple sets of target radar point cloud data and the first calibration plate in the respective position-orientations.

In some optional embodiments, the fourth determining sub-module includes: a fifth determining unit configured to determine a candidate position where the first calibration plate is located according to the extrinsic parameter of the first calibration plate in the position-orientation relative to the camera and the extrinsic parameter reference value between the radar and the camera; a sixth determining unit configured to determine a target plane where the first calibration plate is located from the multiple sets of radar point cloud data in the position-orientation according to the candidate position; and a seventh determining unit configured to determine the set of target radar point cloud data matching the first calibration plate on the target plane corresponding to the multiple sets of radar point cloud data in the position-orientation.

In some optional embodiments, the sixth determining unit includes: a first determining sub-unit configured to determine two or more first radar groups from the multiple sets of radar point cloud data in the position-orientation, wherein each of the two or more first radar groups includes a plurality of first radar points randomly selected and located in an area corresponding to the candidate position and for each of the two or more first radar groups, determine a first plane corresponding to the first radar group, wherein the first plane corresponding to the first radar group includes a plurality of first radar points of the first radar group; a second determining sub-unit configured to, for each of the first planes for the two or more first radar groups, respectively determine distances from other radar points except the plurality of first radar points in the multiple sets of radar point cloud data in the position-orientation to the first plane; a third determining sub-unit configured to, for each of the first planes, determine radar points with a distance less than a threshold among the other radar points as second radar points, and determine the second radar points as radar points included in the first plane; and a fourth determining sub-unit configured to determine a first plane including a largest number of radar points as the target plane among the two or more of the first planes.

In some optional embodiments, the seventh determining unit includes: a fifth determining sub-unit configured to determine an initial first circular area according to a size of the first calibration plate on the target plane; a selection sub-unit configured to randomly select a radar point located in the initial first circular area from the multiple sets of radar point cloud data as a first center of a first circular area to determine a position of the first circular area in the multiple sets of radar point cloud data; a sixth determining sub-unit configured to respectively obtain a plurality of first vectors by taking the first circle center as a starting point and a plurality of third radar points located in the first circular area in the multiple sets of radar point cloud data as ending points; a seventh determining sub-unit configured to add the plurality of first vectors to obtain a second vector; an eighth determining sub-unit configured to determine a target center position of the first calibration plate based on the second vector; and a ninth determining sub-unit configured to determine the set of target radar point cloud data matching the first calibration plate from the multiple sets of radar point cloud data according to the target center position of the first calibration plate and the size of the first calibration plate.

In some optional embodiments, the eighth determining sub-unit is configured to determine an ending point of the second vector as a second circle center, and determining a second circular area according to the second circle center and the size of the first calibration plate; respectively determine a plurality of third vectors by taking the second circle center as a starting point and a plurality of fourth radar points located in the second circular area in the multiple sets of radar point cloud data as ending points; add the plurality of third vectors to obtain a fourth vector; determine whether a vector value of the fourth vector converges to a preset value; if the vector value of the fourth vector converges to the preset value, determine the second circle center corresponding to the fourth vector which converges as a candidate center position of the first calibration plate; and if the candidate center position is coincident with a center position of the first calibration plate, determine the candidate center position as the target center position.

In some optional embodiments, the eighth determining sub-unit is further configured to, if the vector value of the fourth vector does not converge to the preset value, determine an ending point of the fourth vector which does not converge as the second circle center, and redetermining the plurality of third vectors and the fourth vector.

In some optional embodiments, the eighth determining sub-unit is further configured to, if the candidate center position is not coincident with the center position of the first calibration plate, redetermine the candidate center position.

In some optional embodiments, the fifth determining sub-module includes: an eighth determining unit configured to determine a candidate extrinsic parameter between the radar and the camera according to g matching relationships, wherein g is an integer greater than or equal to 3; and determine the target extrinsic parameter between the radar and the camera according to a plurality of the candidate extrinsic parameters between the radar and the camera.

In some optional embodiments, the eighth determining unit includes: a tenth determining sub-unit configured to project, by the radar, the first calibration plate onto a first image of the plurality of first images based on each of the plurality of candidate extrinsic parameters to generate a respective set of projection data; an eleventh determining sub-unit configured to determine a set of projection data having a highest matching degree with the first image among the respective sets of projection data corresponding to the plurality of candidate extrinsic parameters as target projection data; and a twelfth determining sub-unit configured to determine a candidate extrinsic parameter corresponding to the target projection data as the target extrinsic parameter between the radar and the camera.

In some optional embodiments, the radar and the camera are deployed on a vehicle, and the radar is a lidar.

In some optional embodiments, a second calibration plate is located within a field of view range of the camera and is configured to calibrate the first intrinsic parameter of the camera; wherein a distance between the camera and a ground is greater than a distance between the radar and the ground, wherein a horizontal distance between the second calibration plate and the camera is less than a horizontal distance between the first calibration plate and the camera, and wherein a plurality of second images collected using the second calibration plate include a complete second calibration plate.

In some optional embodiments, the plurality of first images include a complete first calibration plate, and the multiple sets radar point cloud data include point cloud data obtained based on the complete first calibration plate.

Generally, the device embodiments correspond to the method embodiments, related details can be referred to part of the description of the method embodiments. The device embodiments described above are merely illustrative, where the units described as separate components may or may not be physically separated, and the components displayed as units may or may not be physical units. That is, the units may be located in one place, or distributed to multiple network units. Some or all of the modules can be selected according to actual needs to achieve the objectives of the solutions of the embodiments, which can be understood and implemented by those of ordinary skill in the art without inventive works.

An embodiment of the present disclosure further provides a computer readable storage medium storing a computer program. When being executed by a processor, the computer program causes the processor to implement the calibration method for a sensor provided in any one of the examples above. Herein, the computer readable storage medium can be a non-volatile storage medium.

In some optional embodiments, an embodiment of the present disclosure provides a computer program product, including computer readable codes, when running on a device, the computer readable codes cause the device to execute instructions to implement the calibration method for a sensor provided in any one of the examples above.

In some optional embodiments, an embodiment of the present disclosure also provides another computer program product for storing computer readable instructions. When the instructions are executed, the computer executes the calibration method for a sensor provided in any one of the examples above.

The computer program product may be specifically realized by means of hardware, software or a combination thereof. In an optional embodiment, the computer program product is specifically embodied as a computer storage medium. In another optional embodiment, the computer program product is specifically embodied as software products, such as a Software Development Kit (SDK).

An embodiment of the present disclosure also provides a calibration apparatus for a sensor, including: a processor:, a memory for storing executable instructions of the processor; wherein the processor is configured to invoke the executable instructions to implement the calibration method for a sensor provided in any one of the examples above.

FIG. 25 is a schematic diagram showing a hardware structure of a calibration apparatus for a sensor provided by an embodiment of the present disclosure. The calibration apparatus for a sensor 310 includes a processor 311, and can also include an input device 312, an output device 313, a memory 314 and a bus 315. The input device 312, the output device 313, the memory 314 and the processor 311 are connected to each other through the bus 315.

The memory includes but is not limited to a random access memory (RAM), a read-only memory (ROM), an erasable programmable read only memory (EPROM), or a portable read-only memory (compact disc read-only memory, CD-ROM), which is used for related instructions and data.

The input device is used to input data and/or signals, and the output device is used to output data and/or signals. The output device and the input device can be independent devices or an integrated device.

The processor can include one or more processors, for example, including one or more central processing units (CPUs). In the case where the processor is a CPU, the CPU can be a single-core CPU, or can also be a multi-core CPU.

The processor is used to invoke the program code and data in the memory to execute the steps in the foregoing method embodiment. For details, reference can be made to the description in the method embodiment, which will not be repeated here.

It can be understood that FIG. 25 only shows a simplified design of a calibration apparatus for a sensor. In practical applications, the calibration apparatus for a sensor can also contain other necessary components, including but not limited to any number of input/output devices, processors, controllers, memories, etc., and all the devices for calibrating a sensor that can implement the embodiments of the present disclosure are all within the scope of protection of present disclosure.

In some embodiments, the functions provided by or the modules included in the apparatuses provided in the embodiments of the present disclosure may be used to implement the methods described in the foregoing method embodiments. For specific implementations, reference may be made to the description in the method embodiments above. For the purpose of brevity, details are not described here repeatedly.

The embodiment of the present disclosure also provides a calibration system, including a camera, a radar and a first calibration plate, wherein the first calibration plate is located within a common field of view range of the camera and the radar, and position-orientation information of the first calibration plate at different collection times is different.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the disclosure as come within known or customary practice in the art. It is intended that the specification and examples be considered as exemplary only, with a true scope and spirit of the disclosure being indicated by the following claims.

The above are only some embodiments of the present disclosure, and are not intended to limit the present disclosure. Any modification, equivalent substitution, improvement, etc. made within the spirit and principle of the present disclosure should be included in the scope of protection of the present disclosure.

1. A calibration method for a sensor, comprising:
collecting a plurality of first images by a camera of the sensor, wherein the sensor comprises the camera and a radar, a first calibration plate is located within a common field of view range of the radar and the camera, and position-orientation information of the first calibration plate in respective position-orientations in the plurality of first images is different;
obtaining a first intrinsic parameter of the camera calibrated in advance;
respectively determining an extrinsic parameter of the first calibration plate in each of the respective position-orientations relative to the camera according to the first intrinsic parameter and the plurality of first images;
obtaining multiple sets of radar point cloud data of the first calibration plate in the respective position-orientations; and
determining a target extrinsic parameter between the radar and the camera according to the extrinsic parameter of the first calibration plate in each of the respective position-orientations relative to the camera and the multiple sets of radar point cloud data.

2. The calibration method according to claim 1, wherein, before obtaining the first intrinsic parameter of the camera calibrated in advance, the calibration method further comprises:
in response to determining that an initial calibration of the sensor is being performed for a first time, calibrating the camera to obtain the first intrinsic parameter of the camera, and
wherein obtaining the first intrinsic parameter of the camera calibrated in advance comprises:
in response to calibrating the sensor again, obtaining the first intrinsic parameter of the camera obtained by the initial calibration of the sensor.

3. The calibration method according to claim 2, wherein a second calibration plate is located within a field of view range of the camera, and
wherein calibrating the camera to obtain the first intrinsic parameter of the camera comprises:
collecting a plurality of second images by the camera, wherein position-orientation information of the second calibration plate in the plurality of second images is different;
respectively determining a plurality of first candidate intrinsic parameters of the camera according to the plurality of second images, wherein each of the plurality of second images corresponds to a respective one of the plurality of first candidate intrinsic parameters; and
determining one of the plurality of first candidate intrinsic parameters as the first intrinsic parameter.

4. The calibration method according to claim 3, wherein determining one of the plurality of first candidate intrinsic parameters as the first intrinsic parameter comprises:
projecting, by the camera, a preset point located in a camera coordinate system to a pixel coordinate system according to the plurality of first candidate intrinsic parameters, to obtain a plurality of first coordinate values of the preset point in the pixel coordinate system;
for each of the plurality of first candidate intrinsic parameters, obtaining a second coordinate value of the preset point in a verification image, and determining a first coordinate value corresponding to the second coordinate value to obtain a set of coordinate pairs with a corresponding relationship, wherein the verification image comprises one or more of the plurality of second images;
for each of the plurality of first candidate intrinsic parameters, determining a respective distance between the first coordinate value and the second coordinate value in the set of coordinate pairs included in the first candidate intrinsic parameter; and
determining a first candidate intrinsic parameter with a smallest distance among the respective distances for the plurality of first candidate intrinsic, parameters as the first intrinsic parameter of the camera.

5. The calibration method according to claim 1, wherein respectively determining the extrinsic parameter of the first calibration plate in each of the respective position-orientations relative to the camera according to the first intrinsic parameter and the plurality of first images comprises:
for each of the plurality of first images, performing de-distortion processing on the first image according to the first intrinsic parameter to obtain a third image corresponding to the first image;
determining a second intrinsic parameter of the camera according to a plurality of third images corresponding to the plurality of first images; and
respectively determining the extrinsic parameter of the first calibration plate in each of the respective position-orientations relative to the camera according to the plurality of the third images and the second intrinsic parameter of the camera.

6. The calibration method according to claim 5, wherein respectively determining the extrinsic parameter of the first calibration plate in each of the respective position-orientations relative to the camera according to the plurality of the third images and the second intrinsic parameter of the camera comprises:
determining a respective homography matrix corresponding to each of the plurality of the third images to obtain a plurality of respective homography matrices; and
determining the extrinsic parameter of the first calibration plate in each of the respective position-orientations relative to the camera according to the second intrinsic parameter of the camera and the plurality of respective homography matrices.

7. The calibration method according to claim 6, wherein determining the target extrinsic parameter between the radar and the camera according to the extrinsic parameter of the first calibration plate in each of the respective position-orientations relative to the camera and the multiple sets of radar point cloud data comprises:
for the first calibration plate in each of the respective position-orientations, determining a set of target radar point cloud data matching the first calibration plate from the multiple sets of radar point cloud data in the position-orientation according to the extrinsic parameter of the first calibration plate in the position-orientation relative to the camera and an extrinsic parameter reference value between the radar and the camera; and
determining the target extrinsic parameter between the radar and the camera according to matching relationships between multiple sets of target radar point cloud data and the first calibration plate in the respective position-orientations.

8. The calibration method according to claim 7, wherein determining the set of target radar point cloud data matching the first calibration plate from multiple sets of radar point cloud data in the position-orientation according to the extrinsic parameter of the first calibration plate in the position-orientation relative to the camera and the extrinsic parameter reference value between the radar and the camera comprises:
determining a candidate position where the first calibration plate is located according to the extrinsic parameter of the first calibration plate in the position-orientation relative to the camera and the extrinsic parameter reference value between the radar and the camera;
determining a target plane where the first calibration plate is located from the multiple sets of radar point cloud data in the position-orientation according to the candidate position; and
determining the set of target radar point cloud data matching the first calibration plate on the target plane corresponding to the multiple sets of radar point cloud data in the position-orientation.

9. The calibration method according to claim 8, wherein determining the target plane where the first calibration plate is located from the multiple sets of radar point cloud data in the position-orientation according to the candidate position comprises:
determining two or more first radar groups from the multiple sets of radar point cloud data in the position-orientation, wherein each of the two or more first radar groups comprises a plurality of first radar points randomly selected and located in an area corresponding to the candidate position;
for each of the two or more first radar groups, determining a first plane corresponding to the first radar group, wherein the first plane corresponding to the first radar group comprises a plurality of first radar points of the first radar group;
for each of the first planes for the two or more first radar groups, respectively determining distances from other radar points except the plurality of first radar points in the multiple sets of radar point cloud data in the position-orientation to the first plane;
for each of the first planes, determining radar points with a distance less than a threshold among the other radar points as second radar points;
for each of the first planes, determining the second radar points as radar points included in the first plane; and
determining a first plane comprising a largest number of radar points as the target plane among the two or more of the first planes.

10. The calibration method according to claim 8, wherein determining the set of target radar point cloud data matching the first calibration plate on the target plane corresponding to the multiple sets of radar point cloud data in the position-orientation comprises:
determining an initial first circular area according to a size of the first calibration plate on the target plane;
randomly selecting a radar point located in the initial first circular area from the multiple sets of radar point cloud data as a first center of a first circular area to determine a position of the first circular area in the multiple sets of radar point cloud data;
respectively obtaining a plurality of first vectors by taking the first circle center as a starting point and a plurality of third radar points located in the first circular area in the multiple sets of radar point cloud data as ending points;
adding the plurality of first vectors to obtain a second vector;
determining a target center position of the first calibration plate based on the second vector: and
determining the set of target radar point cloud data matching the first calibration plate from the multiple sets of radar point cloud data according to the, target center position of the first calibration plate and the size of the first calibration plate.

11. The calibration method according to claim 10, wherein determining the target center position of the first calibration plate based on the second vector comprises:
determining an ending point of the second vector as a second circle center, and determining a second circular area according to the second circle center and the size of the first calibration plate;
respectively determining a plurality of third vectors by taking the second circle center as a starting point and a plurality of fourth radar points located in the second circular area in the multiple sets of radar point cloud data as ending points;
adding the plurality of third vectors to obtain a fourth vector;
determining whether a vector value of the fourth vector converges to a preset value;
if the vector value of the fourth vector converges to the preset value, determining the second circle center corresponding to the fourth vector which converges as a candidate center position of the first calibration plate; and
if the candidate center position is coincident with a center position of the first calibration plate, determining the candidate center position as the target center position.

12. The calibration method according to claim 11, further comprising:
if the vector value of the fourth vector does not converge to the preset value, determining an ending point of the fourth vector which does not converge as the second circle center, and redetermining the plurality of third vectors and the fourth vector.

13. The calibration method according to claim 11, further comprising:
if the candidate center position is not coincident with the center position of the first calibration plate, redetermining the candidate center position.

14. The calibration method according to claim 7, wherein determining the target extrinsic parameter between the radar and the camera according to the matching relationships between multiple sets of the target radar point cloud data and the first calibration plate in the position-orientations comprises:
determining a candidate extrinsic parameter between the radar and the camera according to g matching relationships, wherein g is an integer greater than or equal to 3; and
determining the target extrinsic parameter between the radar and the camera according to a plurality of the candidate extrinsic parameters between the radar and the camera.

15. The calibration method according to claim 14, wherein determining the target extrinsic parameter between the radar and the camera according to the plurality of the candidate extrinsic parameters between the radar and the camera comprises:
projecting, by the radar, the first calibration plate onto a first image of the plurality of first images based on each of the plurality of candidate extrinsic parameters to generate a respective set of projection data;
determining a set of projection data having a highest matching degree with the first image among the respective sets of projection data corresponding to the plurality of candidate extrinsic parameters as target projection data; and
determining a candidate extrinsic parameter corresponding to the target projection data as the target extrinsic parameter between the radar and the camera.

16. The calibration method according to claim 1, wherein the radar and the camera are deployed on a vehicle, and the radar is a lidar.

17. The calibration method according to claim 16, wherein a second calibration plate is located within a field of view range of the camera and is configured to calibrate the first intrinsic parameter of the camera,
wherein a distance between the camera and a ground is greater than a distance between the radar and the ground,
wherein a horizontal distance between the second calibration plate and the camera is less than a horizontal distance between the first calibration plate and the camera, and
wherein a plurality of second images collected using the second calibration plate comprise a complete second calibration plate.

18. The calibration method according to claim 1, wherein the plurality of first images comprise a complete first calibration plate, and the multiple sets radar point cloud data comprise point cloud data obtained based on the complete first calibration plate.

19. A calibration apparatus for a sensor, comprising:
at least one processor; and
at least one non-transitory memory coupled to the at least one processor and storing programming instructions for execution by the at least one processor to:
collect a plurality of first images by a camera of the sensor, wherein the sensor comprises the camera and a radar, a first calibration plate is located within a common field of view range of the radar and the camera, and position-orientation information of the first calibration plate in respective position-orientations in the plurality of first images is different;
obtain a first intrinsic parameter of the camera calibrated in advance;
respectively determine an extrinsic parameter of the first calibration plate in each of the respective position-orientations relative to the camera according to the first intrinsic parameter and the plurality of first images;
obtain multiple sets of radar point cloud data of the first calibration plate in the respective position-orientations; and
determine a target extrinsic parameter between the radar and the camera according to the extrinsic parameter of the first calibration plate in each of the respective position-orientations relative to the camera and the multiple sets of radar point cloud data.

20. A calibration system, comprising:
a camera;
a radar;
a first calibration plate, wherein the first calibration plate is located within a common field of view range of the camera and the radar, and position-orientation information of the first calibration plate in respective position-orientations at different collection times is different; and
a calibration device comprising:
at least one processor; and
at least one non-transitory memory coupled to the at least one processor and storing programming instructions for execution by the at least one processor to:
collect a plurality of first images by a camera;
obtain a first intrinsic parameter of the camera calibrated in advance;
respectively determine an extrinsic parameter of the first calibration plate in each of the respective position-orientations relative to the camera according to the first intrinsic parameter and the plurality of first images;
obtain multiple sets of radar point cloud data of the first calibration plate in the respective position-orientations; and
determine a target extrinsic parameter between the radar and the camera according to the extrinsic parameter of the first calibration plate in each of the respective position-orientations relative to the camera and the multiple sets of radar point cloud data.
